(19) United States
(12) Patent Application Publication
(10) Pub. No.: US 2014/0316689 A1
(43) Pub. Date: Oct. 23, 2014

(54) ELECTRONIC DEVICE AND ANTICOLLISION ALARMING METHOD

(71) Applicant: FIH (Hong Kong) Limited, Kowloon (HK)

(72) Inventor: CHIA-WEI CHANG, New Taipei (TW)

(73) Assignee: FIH (HONG KONG) LIMITED, Kowloon (HK)

(21) Appl. No.: 14/052,700

(22) Filed: Oct. 12, 2013

(30) Foreign Application Priority Data
Apr. 19, 2013 (TW) 102114099

(51) Int. Cl. G08G 9/02

(52) U.S. Cl. CPC G08G 9/02
USPC 701/301

(57) ABSTRACT

In a method of monitoring an actual distance between a first vehicle and a second vehicle, using a recipient electronic device which is positioned in the second vehicle positioned after the first vehicle, the recipient electronic device calculates the actual distance according to position information of the first and the second vehicles, and reminds a driver of the second vehicle to adjust a driving speed when the actual distance is less than a predetermined value.

### BACKGROUND

1. Technical Field

Embodiments of the present disclosure relate to monitoring technology, and more particularly to an electronic device and an anticollision alarming method using the electronic device.

2. Description of Related Art

Transportation accidents usually occurs when a driver of a vehicle does not properly control his/her driving speed. What is needed, therefore, is an electronic device and a monitoring method to overcome the aforementioned problem.

### BRIEF DESCRIPTION OF THE DRAWINGS

FIG. 1 is a block diagram of one embodiment of a first electronic device and a second electronic device including a monitoring system.

FIG. 2 is a block diagram of function modules of the monitoring system included in the first and second electronic devices of FIG. 1.

FIG. 3 is a first flowchart of one embodiment of a monitoring method to monitor an actual distance between a first vehicle and a second vehicle.

FIG. 4 is a second flowchart of one embodiment of the monitoring method to monitor the actual distance between the first vehicle and the second vehicle.

FIG. 5A illustrates an example of a first distance between the first electronic device and a rearmost end of the first vehicle.

FIG. 5B illustrates an example of a second distance between the second electronic device and a forefront end of the second vehicle.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

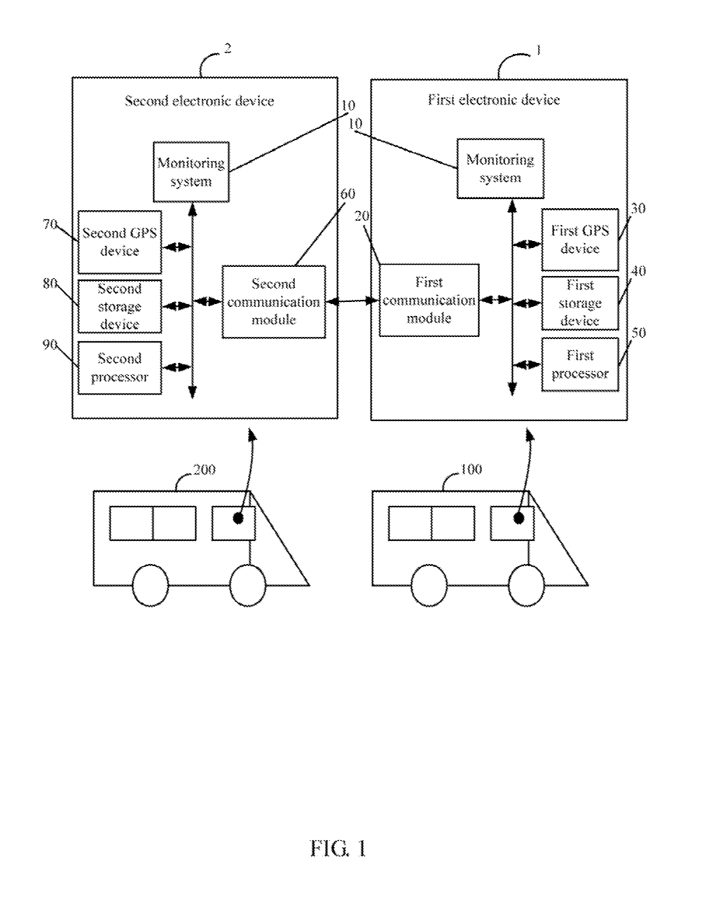

FIG. 1 is a block diagram of one embodiment of a first electronic device 1 in communication with a second electronic device 2. The first electronic device 1 and the second electronic device 2 may be mobile phones, personal digital assistants (PDAs), tablet computers, or other computing devices.

In one embodiment, the first electronic device 1 is positioned in a first vehicle 100, and the second electronic device 2 is positioned in a second vehicle 200. In this disclosure, it is assumed that the first vehicle 100 is positioned in front of the second vehicle 200. In other embodiments, the first electronic device 1 may be positioned in the second vehicle 200, and the second electronic device 2 may be positioned in the first vehicle 100. The first vehicle 100 and the second vehicle 200 may be bicycles, motorcycles, motorcars, trains, or other transportations vehicles such as steamboats.

In one embodiment, the first electronic device 1 and the second electronic device 2 may be positioned on predetermined locations of the first vehicle 100 and the second vehicle 200, respectively. For example, the first electronic device 1 and the second electronic device 2 are positioned in cabs of the first vehicle 100 and the second vehicle 200, respectively.

In one embodiment, the first electronic device 1 includes a first communication module 20, a first Global Positioning System (GPS) device 30, a first storage device 40, and a first processor 50. The second electronic device 2 includes a second communication module 60, a second GPS device 70, a second storage device 80, and a second processor 90. In one embodiment, the first communication module 20 and the second communication module 60 are wireless communication modules. That is, the first electronic device 1 and the second electronic device 2 can communicate wirelessly using the first communication module 20 and the second communication module 60.

The first GPS device 30 detects first position information of the first vehicle 100, and the second GPS device 70 detects second position information of the second vehicle 200. Each of the first and the second position information include, but are not limited to latitudes and longitudes of the first vehicle 100 or the second vehicle 200.

In some embodiments, both of the first electronic device 1 and the second electronic device 2 include a monitoring system 10. The monitoring system 10 monitors an actual distance between the first vehicle 100 and the second vehicle 200, according to the first and the second position information, and reminds the driver of the second vehicle 200, to adjust a driving speed when the actual distance is less than a predetermined value. Further details are provided below.

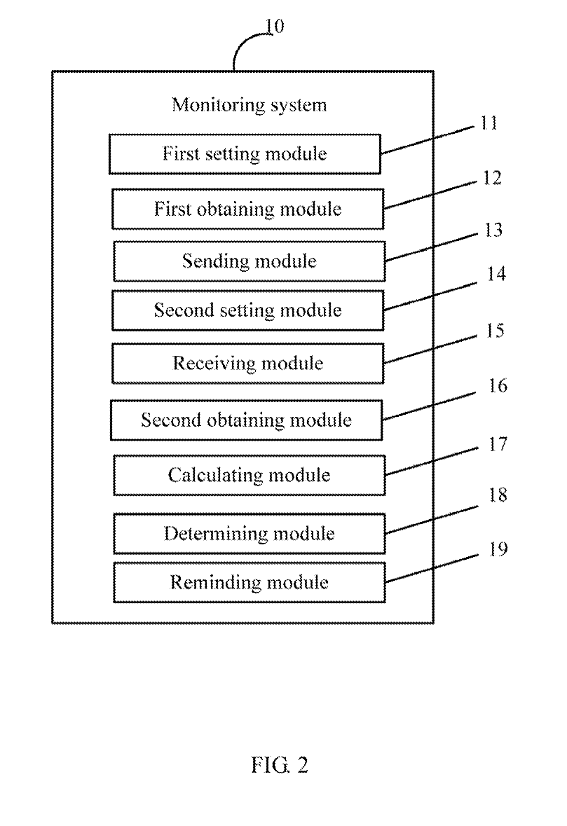

FIG. 2 is a block diagram of function modules of the monitoring system 10 included in the first electronic device 1 and the second electronic device 2 of FIG. 1. In one embodiment, the monitoring system 10 may include a first setting module 11, a first obtaining module 12, a sending module 13, a second setting module 14, a receiving module 15, a second obtaining module 16, a calculating module 17, a determining module 18, and a reminding module 19. The modules 11˜19 comprise computerized codes in the form of one or more programs that may be stored in each of the first storage device 40 and the second storage device 80. The computerized code includes instructions that are executed by the first processor 50 or by the second processor 90 to provide functions for the modules.

In these embodiments, as mentioned above, it is assumed that the first vehicle 100 is positioned in front of the second vehicle 200, thus, the first electronic device 1 acts as a sender electronic device to send the first position information to the second electronic device 2, and the second electronic device 2 acts as a recipient electronic device to receive the first position information.

In other embodiments, when the second vehicle 200 overtakes the first vehicle 100, then the second electronic device 2 acts as the sender electronic device, and the first electronic device 1 acts as the recipient electronic device.

For the purpose of describing the monitoring system 10 explicitly below, the first electronic device 1 is considered as the sender electronic device, and the second electronic device 2 is considered as the recipient electronic device.

When the first electronic device 1 acts as the sender electronic device, the first processor 50 of the first electronic device 1 executes the modules 11˜13, and the second processor 90 of the second electronic device 2 executes the modules 14˜19.

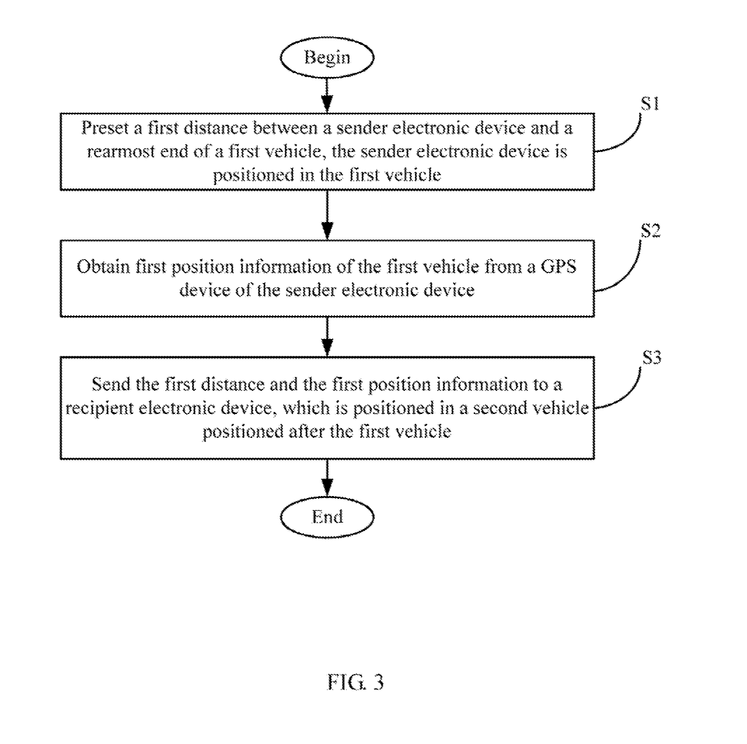

FIG. 3 is a first flowchart of one embodiment of a monitoring method to monitoring the actual distance between the first vehicle 100 and the second vehicle 200. Depending on the embodiment, additional blocks may be added, others deleted, and the ordering of the blocks may be changed.

In step S1, the first setting module 11 presets a first distance between the first electronic device 1 and a rearmost end 101 of the first vehicle 100.

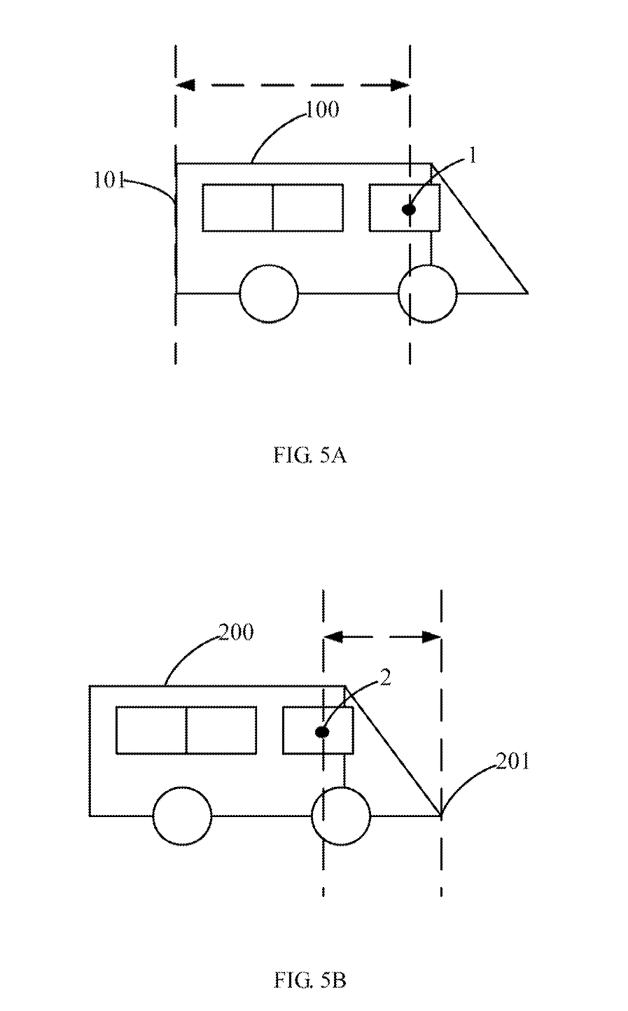

It should be noted that, if the actual distance is more accurate, the driver of the second vehicle 200 controls the driving speed better. As shown in FIG. 5A, the first setting module 11 may preset the first distance equal to a first value, which is measured between the first electronic device 1 and the rearmost end 101.

In step S2, the first obtaining module 12 obtains the first position information of the first vehicle 100, from the first GPS device 30 at each predetermined time interval (e.g., 10 seconds).

As mentioned above, the first position information includes the latitude and longitude of the first vehicle 100. For example, the first obtaining module 12 obtains a first latitude and a first longitude at a first time Ts. The first obtaining module 12 further obtains updated first position information (e.g., a second latitude and a second longitude) at a second time (T+10)s.

In step S3, the sending module 13 sends the first distance and the first position information to the second electronic device 2 (i.e., the recipient electronic device), which is positioned in the second vehicle 200 positioned behind the first vehicle 100.

For example, the sending module 13 sends the first latitude and the first longitude to second electronic device 2. The sending module 13 further sends updated first position information (e.g., the second latitude and the second longitude) to the second electronic device 2.

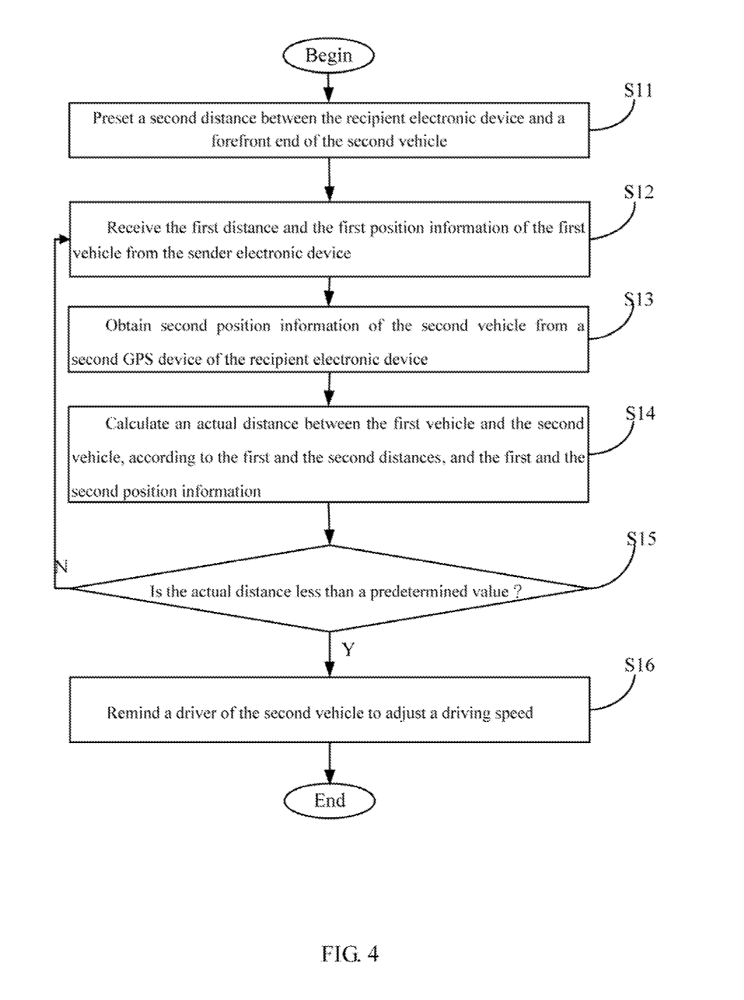

FIG. 4 is a second flowchart of one embodiment of the monitoring method to monitor the actual distance between the first vehicle 100 and the second vehicle 200. Depending on the embodiment, additional blocks may be added, others deleted, and the ordering of the blocks may be changed.

In step S11, the second setting module 14 presets a second distance between the second electronic device 2 and a forefront end 201 of the second vehicle 200.

Similarly, as shown in FIG. 5B, the second setting module 14 may preset that the second distance equal to a second value, which is measured between the second electronic device 2 and the forefront end 201.

In step S12, the receiving module 15 receives the first distance and first position information from the first electronic device 1 (i.e., the sender electronic device) which is positioned in the first vehicle 100 positioned in front of the second vehicle 200.

In step S13, the second obtaining module 16 obtains the second position information of the second vehicle 200 from the second GPS device 70. As mentioned above, the second position information includes latitude and longitude of the second vehicle 200.

In step S14, the calculating module 17 calculates the actual distance between the first vehicle 100 and the second vehicle 200, according to the first and the second distances, and the first and the second position information.

In one embodiment, the calculating module 17 first calculates a reference distance according to the first and the second position information, and then subtracts the first and the second distances from the reference distance to get the actual distance.

In one embodiment, the calculating module 17 calculates the reference distance according to the following formula:

$$Δ = {111.199 [ {( {ϕ}_{1} - {ϕ}_{2} )}^{2} + {( {λ}_{1} - {λ}_{2} )}^{2} {cos}^{2} ( \frac{{ϕ}_{1} + {ϕ}_{2}}{2} ) ]}^{\frac{1}{2}}$$

The “Δ” indicates the actual distance, and the “φ₁” indicates the latitude of the first vehicle 100, and the “λ₁” indicates the longitude of the first vehicle 100. The “φ₂” indicates the latitude of the second vehicle 200, and the “λ₂” indicates the longitude of the second vehicle 200.

In step S15, the determining module 18 determines whether the actual distance is less than the predetermined value. If the actual distance is less than the predetermined value, step S16 is implemented. If the actual distance is not less than the predetermined value, the process goes back to step S12.

In step S16, the reminding module 19 reminds the driver of the second vehicle 200 to adjust the driving speed.

In one embodiment, the reminding module 19 reminds the driver by play a alert audio signal, such as “Please reduce the driving speed”, for example.

Although embodiments of the present disclosure have been specifically described, the present disclosure is not to be construed as being limited thereto. Various changes or modifications may be made to the present disclosure without departing from the scope and spirit of the present disclosure.

1. (canceled)

2. (canceled)

3. A method of monitoring an actual distance between a first vehicle and a second vehicle, using a recipient electronic device which is positioned in the second vehicle, the recipient electronic device comprising a Global Positioning System (GPS) device, and at least one processor, the method comprising:
presetting a second distance between the recipient electronic device and a forefront end of the second vehicle;
receiving, from a sender electronic device which is positioned in the first vehicle, a first distance between the position of the sender electronic device and a rearmost end of the first vehicle, and first position information of the first vehicle when the first vehicle is positioned in front of the second vehicle;
obtaining second position information of the second vehicle from the GPS device;
calculating the actual distance, according to the first and the second distances, and the first and the second position information;
reminding a driver of the second vehicle to adjust a driving speed, when the actual distance is less than a predetermined value; and
transmitting the second distance and the second position information to the sender electronic device when the second vehicle is overtake the first vehicle, the sender electronic device monitoring the actual distance according to the first and the second distances, the first position and the second information, and reminding a driver of the first vehicle to adjust a driving speed when the actual distance is less than a predetermined value.

4. The method according to claim 3, wherein the actual distance is calculated by:
calculating a reference distance according to the first and the second position information; and
subtracting the first and the second distances from the reference distance to get the actual distance.

5. An electronic device which is positioned in a second vehicle, comprising:
a Global Positioning System (GPS) device;
at least one processor; and
a storage device storing one or more computer-readable programs, which when executed by the at least one processor, the one or more programs comprising:
a second setting module configured to preset a second distance between the electronic device and a forefront end of the second vehicle;
a receiving module configured to receive, from a sender electronic device which is positioned in a first vehicle, a first distance between the position of the sender electronic device and a rearmost end of the first vehicle, and first position information of the first vehicle, when the first vehicle is positioned in front of the second vehicle;
a second obtaining module configured to obtain second position information of the second vehicle from the GPS device;
a calculation module configured to calculate an actual distance between the first vehicle and the second vehicle, according to the first and the second distances, and the first and the second position information;
a reminding module configured to remind a driver of the second vehicle to adjust a driving speed, when the actual distance is less than a predetermined value; and
a sending module configured to transmit the second distance and the second position information to the sender electronic device when the second vehicle is overtake the first vehicle, the sender electronic device monitoring the actual distance according to the first and the second distances, the first position and the second information, and remind a driver of the first vehicle to adjust a driving speed when the actual distance is less than a predetermined value.

6. The electronic device of claim 5, wherein the calculation module calculates the actual distance by:
calculating a reference distance according to the first and the second position information; and
subtracting the first and the second distances from the reference distance to get the actual distance.
